(19) United States
(12) Patent Application Publication
(10) Pub. No.: US 2013/0085700 A1
(43) Pub. Date: Apr. 4, 2013

(54) TECHNIQUES FOR IMPROVED PEDOMETER READINGS

(71) Applicants: Yash Rohit Modi, San Francisco, CA (US); Vinay Bethgeri Ganesh Dixit, Sunnyvale, CA (US); Saurabh Gupta, Sunnyvale, CA (US)

(72) Inventors: Yash Rohit Modi, San Francisco, CA (US); Vinay Bethgeri Ganesh Dixit, Sunnyvale, CA (US); Saurabh Gupta, Sunnyvale, CA (US)

(73) Assignee: APPLE INC., Cupertino, CA (US)

(21) Appl. No.: 13/251,136

(22) Filed: Sep. 30, 2011

(51) Int. Cl. G01C 22/00; G01P 21/00; G06F 15/18; G06F 19/00

(52) U.S. Cl. 702/104; 702/160; 706/12

(57) ABSTRACT

Techniques are provided for improving pedometer readings. In some embodiments, motion data, such as acceleration data is detected, and a magnitude of the acceleration data, referred to as the modulus, is processed. Techniques involve performing frequency analysis on the modulus. In some embodiments, the modulus samples are counted perform frequency analysis on each complete sample set. Each complete sample set includes overlapping samples with the previous sample set. A suitable frequency analysis algorithm, such as fast Fourier transform (FFT) dominant frequency computation is performed on each sample set to determine the dominant frequency of the modulus. The dominant frequency of the modulus may be smoothed in some embodiments to remove irregularities such as spikes or periods of inactivity. In some embodiments, results of frequency analysis may be used to determine whether a detected step is a walking step or a running step.

### BACKGROUND

The present disclosure relates generally to electronic devices, and more specifically to electronic devices suitable for providing pedometer readings.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Electronic devices, and in particular portable electronic devices (e.g., portable media players and cellular telephones), are increasingly used for various user interactions. For example, electronic devices may be used as a pedometer to determine a user's steps taken, distance traveled, and/or calories expended. Such electronic devices often include one or more motion sensors, such as an accelerometer or gyroscope, for detecting the orientation and/or movement of the device which may represent the movement of the user carrying the device. The electronic device may process the data generated by the motion sensors and perform various calculations to obtain data based on the processed motion sensor data.

While conventional electronic devices may process motion sensor data to determine the number of steps taken by a user, an estimated distance traveled by a user, and/or a number of calories expended by a user during the measured activity, such devices may not provide certain data with sufficient accuracy. For example, electronic devices may typically estimate distance traveled based on the number of detected steps and an estimated stride length. However, conventional electronic devices may not accurately detect steps and/or estimate a user's stride length. For instance, some devices may not be suitable for differentiating between walking steps and running steps. Moreover, some devices use imprecise estimated stride lengths based on user-entered data, and additionally, the estimated stride lengths may be fixed. Such techniques may result in inaccuracies in detecting distance.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present techniques are directed towards improved pedometer readings. In some embodiments, step detection may be performed by applying adaptive threshold filtering and adaptive frequency filtering on motion data detected by a pedometer. In some embodiments, the motion data may include a magnitude of acceleration data, referred to as an acceleration modulus or a modulus signal. The threshold and frequency filtering techniques may be adaptable based on frequency analysis of the acceleration data. In some embodiments, frequency analysis involves calculating the dominant frequency of the acceleration data and may involve any suitable algorithm for determining the dominant frequency in motion data detected by the pedometer, such as fast Fourier transform (FFT) dominant frequency computation. In some embodiments, the modulus signal samples are counted perform frequency analysis on each complete sample set of modulus samples. Each complete sample set includes overlapping samples with the previous sample set. For example, in one embodiment, a complete sample set includes 1024 samples, and each sample set includes 512 samples in common with its immediately preceding sample set. Such techniques may improve the resolution granularity of the dominant frequency. Furthermore, in some embodiments, the dominant frequency of the modulus may be further processed to remove irregularities such as spikes or periods of inactivity.

### BRIEF DESCRIPTION OF THE DRAWINGS

Various aspects of this disclosure may be better understood upon reading the following detailed description and upon reference to the drawings in which:

FIG. 1 is a block diagram of an electronic device, in accordance with aspects of the present disclosure;

FIG. 2 is a perspective view of a handheld electronic device, in accordance with aspects of the present disclosure;

FIG. 3 is a block diagram of a step detection system, in accordance with aspects of the present disclosure;

FIG. 4 is a graph of an acceleration modulus plotted with respect to time and gravitational acceleration, in accordance with aspects of the present disclosure;

FIG. 5 is a schematic diagram representing different frequency bands used in an adaptive frequency filter, in accordance with aspects of the present disclosure;

FIG. 6 is a flow chart of a process for performing frequency analysis on acceleration data, in accordance with aspects of the present disclosure;

FIG. 7 is a schematic diagram representing overlapping sample sets in frequency analysis, in accordance with aspects of the present disclosure;

FIG. 8 is a flow chart of a process for estimating traveled distance, in accordance with aspects of the present disclosure;

FIG. 9 is a flow chart of a process for estimating the stride length for detected running steps or walking steps, in accordance with aspects of the present disclosure;

FIG. 10 is a flow chart of a process for a least squares simple regression calibration technique, in accordance with aspects of the present disclosure;

FIG. 11 is a flow chart of a process for a least squares multiple regression calibration technique, in accordance with aspects of the present disclosure; and

FIG. 12 is a flow chart of a process for a K-factor calibration technique, in accordance with aspects of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

One or more embodiments are directed towards improved pedometer readings. A pedometer may generally refer to any electronic device having motion sensing and processing capabilities suitable for providing readings such as a step count (which may include running step count, walking step count, or step counts at different paces), estimated distance, calories burned, and other information relating to the motion detected by the pedometer and/or parameters of a user of the pedometer.

Techniques are provided for detecting and counting steps by applying adaptive threshold filtering and adaptive frequency filtering on motion data, such as acceleration data detected by an accelerometer in the pedometer. While conventional step detection involves detecting a step based on an acceleration swing over a fixed threshold, adaptive threshold step detection may improve the accuracy of step detection by detecting acceleration swing about a moving average. Furthermore, the adaptive filtering techniques discussed herein involve determining the dominant frequency of the acceleration data and filtering the acceleration data through a frequency band filter of the dominant frequency. One of several frequency bands may be applied for filtering the dominant frequency, and the adaptive filtering process may include dynamically adjusting the frequency band filter based on frequency variations in the acceleration data.

The threshold and frequency filtering techniques may be adaptable while the pedometer is active (e.g., used by a user during a walk and/or run activity session to measure movement during the activity session). The adaptable characteristic of the threshold and frequency filters are based on frequency analysis of the acceleration data. In some embodiments, frequency analysis involves calculating the dominant frequency of the acceleration data. The dominant frequency may include data representing the motion of a user carrying or wearing the pedometer and/or the steps per second of the user. Frequency analysis may include, for example, fast Fourier transform (FFT), or any other suitable algorithm for determining the dominant frequency in motion data detected by the pedometer. The accelerometer may provide samples of acceleration data, and frequency analysis calculations may be performed for each sample set. In some embodiments, each sample set may include samples from a previously analyzed sample set, thus increasing the frequency analysis performed on each sample to determine the dominant frequency with increased resolution granularity and improved responsiveness to frequency changes.

Frequency analysis and step detection may also involve determining whether a detected step is a walking step or a running step based on the estimated frequency of the detected steps. Typically, distance is calculated based on the number of detected steps and an estimated stride length, and a walking step may have a different stride length compared to a running step. Therefore, differentiation between detected walking steps and running steps may result in more accurate distance estimation.

Furthermore, in one or more embodiments, techniques are provided for calibrating the distance estimated by the pedometer. For example, calibration techniques may include least squares simple regression, least squares multiple regression, or a K-factor approach, etc. Such techniques may involve calibrating the distance estimation process based on a comparison of an estimated distance and an actual distance input by a user of the pedometer.

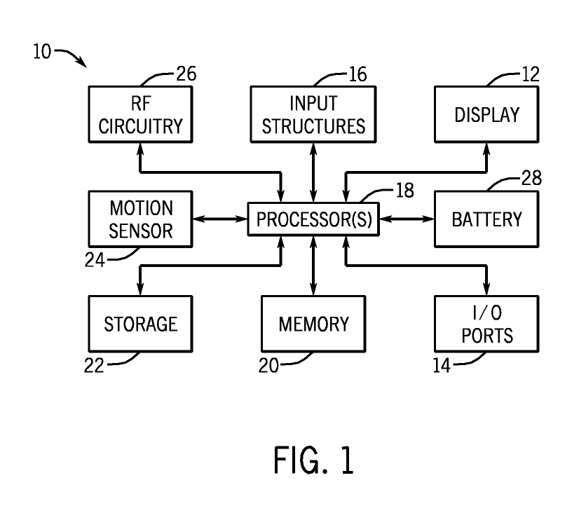

While an electronic device suitable for the present techniques may sometimes be referred to herein as a pedometer, it should be noted that the present techniques may be implemented in any suitable electronic device and is not limited to a device primarily suitable for step detection. As may be appreciated, electronic devices suitable for the present techniques may include various internal and/or external components which contribute to the function of the device. For instance, FIG. 1 is a block diagram illustrating components that may be present in one such electronic device 10. Those of ordinary skill in the art will appreciate that the various functional blocks shown in FIG. 1 may include hardware elements (including circuitry), software elements (including computer code stored on a computer-readable medium, such as a hard drive or system memory), or a combination of both hardware and software elements. FIG. 1 is only one example of a particular implementation and is merely intended to illustrate the types of components that may be present in the electronic device 10. For example, in the presently illustrated embodiment, these components may include a display 12, input/output (I/O) ports 14, input structures 16, one or more processors 18, one or more memory devices 20, non-volatile storage 22, motion sensor 24, networking device 26, and power source 28.

The display 12 may be used to display various images generated by the electronic device 10. The display 12 may be any suitable display, such as a liquid crystal display (LCD) or an organic light-emitting diode (OLED) display. Additionally, in certain embodiments of the electronic device 10, the display 12 may be provided in conjunction with a touch-sensitive element, such as a touch-screen, that may be used as part of the control interface for the device 10. In some embodiments, the display 12 may be suitable for displaying various screens related to step detection, distance estimation, calorie calculation, etc. Furthermore, the display may be suitable for displaying real-time updates relating to an activity measured by a pedometer.

The electronic device 10 may also include various input and/or output ports 14 to allow connection of additional devices. For example, a port 14 may be a headphone or audio jack that provides for connection of headphones or speakers. Additionally, a port 14 may have both input/output capabilities to provide for connection of a headset (e.g. a headphone and microphone combination). Embodiments of the present invention may include any number of input and/or output ports 14, including headphone and headset jacks, universal serial bus (USB) ports, and AC and/or DC power connectors. Further, the device 10 may use the input and output ports 14 to connect to and send or receive data with any other device, such as other portable electronic devices, personal computers, printers, etc.

In one embodiment, one or more of the user input structures 16 are configured to control the device 10, such as by controlling a mode of operation, an output level, an output type, etc. For instance, the user input structures 16 may include a button to turn the device 10 on or off. In general, embodiments of the electronic device 10 may include any number of user input structures 16, including buttons, switches, a touch-sensitive elements of the display 12, a control pad, keys, knobs, a scroll wheel, or any other suitable input structures. The input structures 16 may be used to internet with a user interface displayed on the device 10 to control functions of the device 10 or of other devices connected to or used by the device 10. For example, the user input structures 16 may allow a user to initiate a pedometer application if, for instance, a user wants to have steps counted or distance estimated during an exercise session. Moreover, user input structures 16 may allow a user to enter information (e.g., user parameters such as height, gender, etc.) which may be used for various calculations related to the improved pedometer readings of the present techniques.

The processor(s) 18 may provide the processing capability required to execute the operating system, programs, user interface, and any other functions of the device 10. The processor(s) 18 may include one or more microprocessors, such as one or more “general-purpose” microprocessors, a combination of general and special purpose microprocessors, and/or ASICS. In some embodiments, the processor(s) 18 may be suitable for processing motion data detected by the motion sensor 24, as will be further discussed.

Embodiments of the electronic device 10 may also include a memory 20. The memory 20 may include a volatile memory, such as RAM, and/or a non-volatile memory, such as ROM. The memory 20 may store a variety of information and may be used for a variety of purposes. For example, the memory 20 may store the firmware for the device 10, such as an operating system for the device 10, and/or any other programs or executable code necessary for the device 10 to function. In addition, the memory 20 may be used for buffering or caching during operation of the device 10. For example, the memory 20 may be suitable for storing algorithms and data associated with providing pedometer readings, such as estimating stride length, calculating distance, calibrating, etc.

The motion sensor 24 may include any suitable motion sensor for detecting movements of electronic device 10 or a motion of a user carrying the device 10. In some embodiments, the motion sensor 20 may include one or more three-axis acceleration motion sensors (referred to herein as an accelerometer) which may detect linear acceleration in three directions (i.e., the x-axis or left/right direction, the y-axis or up/down direction, and the z-axis or forward/backward direction). In some embodiments, motion sensor 24 may include one or more single-axis or two-axis acceleration motion sensors which may detect linear acceleration only along each of the x-axis, y-axis, or z-axis, or along any other pair of directions. The motion sensor 24 may detect rotation, rotational movement, angular displacement, tilt, position, orientation, motion along a non-linear path, or any other non-linear motions. Although the present disclosure generally describes sensing motion in the context of a three-axis accelerometer, it should be understood that the discussion may be applied to any suitable sensing mechanism or combination of sensing mechanisms provided by motion sensor 24 of electronic device 10 for generating motion sensor data in response to detecting movement.

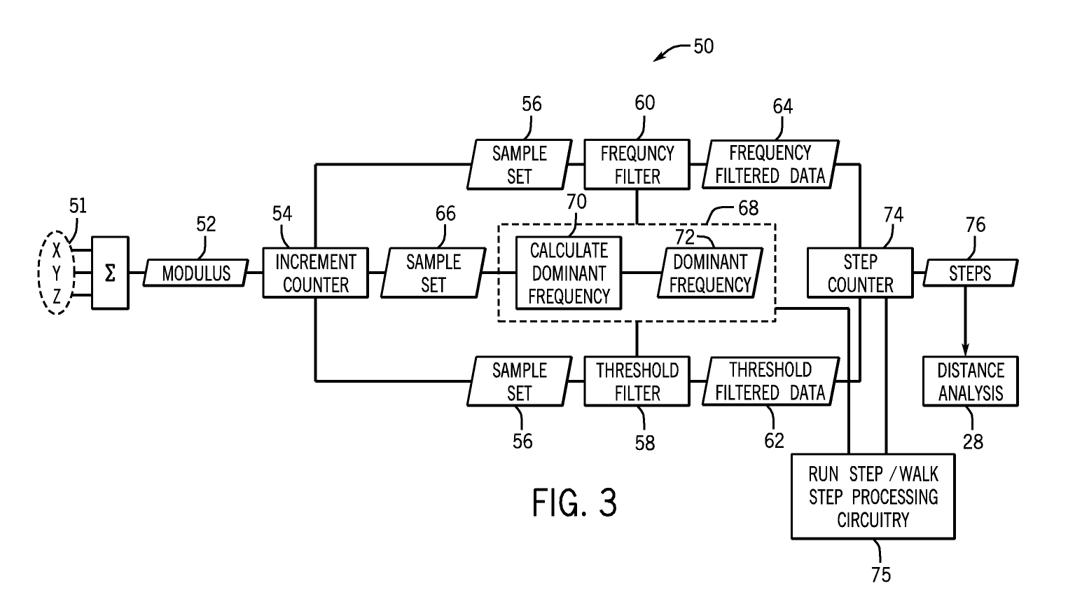

In some embodiments, various electronic devices 10 may include mobile telephones, media players, personal data organizers, handheld game platforms, cameras, and combinations of such devices. For instance, as generally depicted in FIG. 3, the device 10 may be provided in the form of handheld electronic device 36 that includes various functionalities (such as the ability to take pictures, make telephone calls, access the Internet, communicate via email, record audio and video, listen to music, play games, and connect to wireless networks). By way of further example, handheld device 36 may be a model of an iPod®, iPod® Touch, or iPhone® available from Apple Inc. of Cupertino, Calif. In the depicted embodiment, the handheld device 32 includes the display 12, which may be in the form of an LCD 34. The LCD 34 may display various images generated by the handheld device 32, such as a graphical user interface (GUI) 38 having one or more icons 40. A user may perform various functions using touch-screen technology by touching a top surface of a touch-sensitive LCD 34 and accessing the GUI 38.

In another embodiment, the electronic device 10 may also be provided in the form of a portable multi-function tablet computing device (not illustrated). In certain embodiments, the tablet computing device may provide the functionality of two or more of a media player, a web browser, a cellular phone, a gaming platform, a personal data organizer, and so forth. By way of example only, the tablet computing device may be a model of an iPad® tablet computer, available from Apple Inc.

Although an electronic device 10 is generally depicted in the context of a portable electronic device, a device 10 may also take the form of other types of electronic devices. In certain embodiments, an electronic device 10 in the form of a computer suitable for receiving and processing motion data from a motion sensor 24. For example, a computer may receive motion data from a motion sensor 24 through I/O ports 14, or wirelessly via the RF circuitry 26. The computer may then process the motion data in a suitable processor 18 to provide various pedometer readings. Examples of a computer may include a model of a MacBook®, MacBook® Pro, MacBook Air®, iMac®, Mac® mini, or Mac Pro® available from Apple Inc.

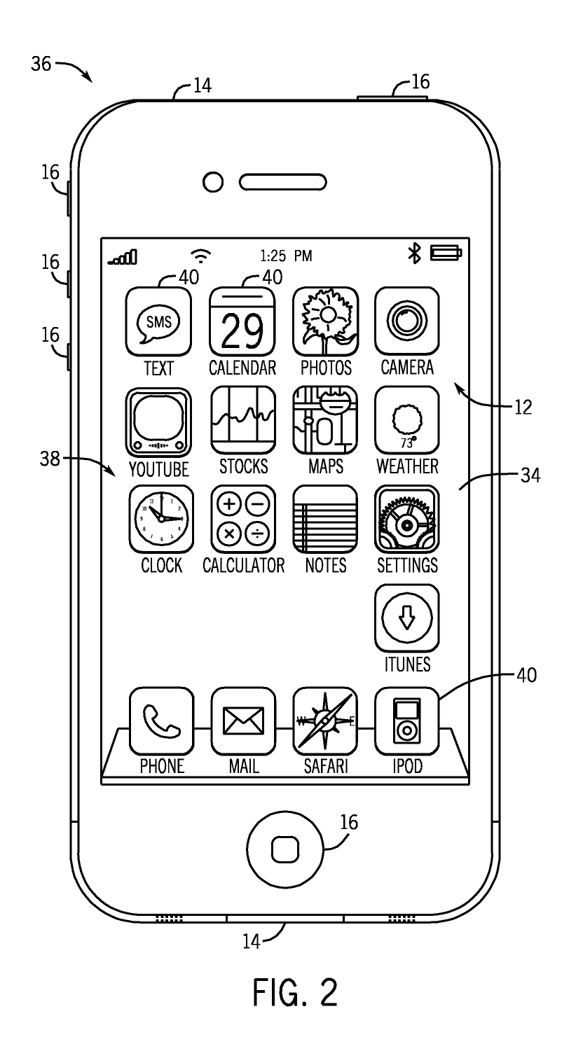

With the foregoing discussion in mind, FIG. 3 depicts a block diagram of step detection system 50 for improved pedometer readings, in accordance with the present techniques. It should be noted that the step detection system 50 includes various components of the electronic device 10 of FIG. 1, which may also be referred to generally as the pedometer, as well as various processes performed by components of the electronic device 10. The step detection system 50 may be utilized when a user of the electronic devices 10 initiates a measurement of the step detection system 10. A measurement may refer to the detection of motion data (e.g., three-axis acceleration measurements) during an interval of time to provide data related to the detected motion data (e.g., step count, distance estimation, calorie calculation) during that interval. For devices 10 which are primarily capable of step detection (e.g., a basic pedometer), distance estimation, and/or calorie calculation, the step detection system 50 may be initiated simply by turning on the device 10 or initiating a new measurement. For devices which are capable of various functions (e.g., a mobile phone, such as illustrated in FIG. 2), the step detection system 50 may be initiated when a user accesses an appropriate GUI 38 (FIG. 2).

Once the step detection system 50 is initiated, the system 50 may use the motion sensor 24 to obtain motion data of the device 10, such as acceleration measurements 51 along the x-axis, y-axis, and z-axis. Such three-axis acceleration measurements 51 may be detected by a three-axis accelerometer, for example, in the motion sensor 24. While three-axis acceleration measurements 51 are represented in FIG. 3, other forms of motion data such as single-axis or two-axis acceleration measurements may also be suitable for the present techniques. In some embodiments, the acceleration measurements 51 may be detected according to the operating frequency of the accelerometer. For example, if the accelerometer has an operation frequency of 100 Hz, the acceleration measurements 51 may be detected every 10 ms.

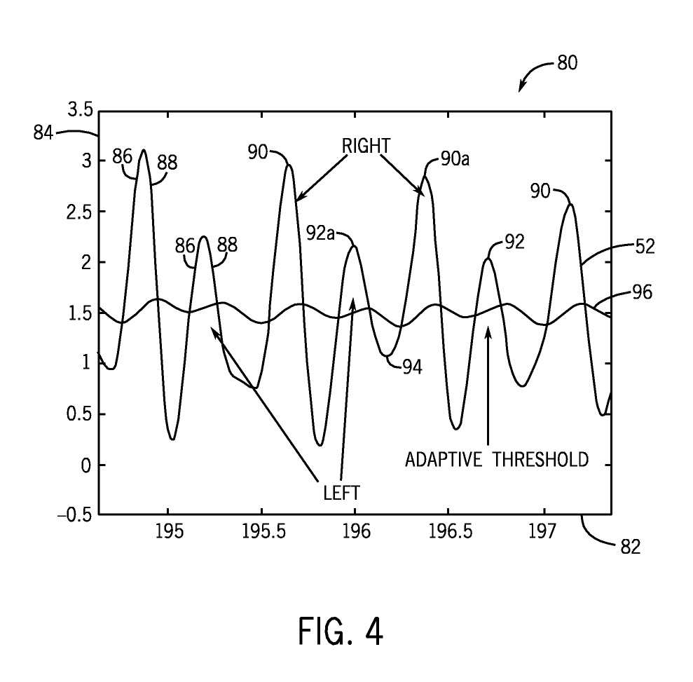

The electronic device 10 (or a suitable processor 18 in the device 10) may calculate the square root of the sum of the squares of the accelerometer measurements 51 (e.g., the square root of x²+y²+z²) to obtain a magnitude of the accelerometer output, referred to as the acceleration modulus 52. Using the magnitude of the acceleration data 51 from three axes may compensate for instances when the device 10 is inconsistently oriented during a measurement of an activity or inconsistently worn or carried throughout the use of the device 10, as the modulus 52 may represent movements of the device 10 substantially irrespective of the orientation of the device 10. FIG. 4 is an illustration of a graph 80 plotting the acceleration modulus 52 over a time axis 82 (in seconds) and an acceleration axis 84 (in gravitational acceleration).

Referring back to FIG. 3, the modulus 52 may be processed in the step detection system 50 by various adaptive filters, such as an adaptive threshold filter 58 and an adaptive frequency filter 60. The adaptive threshold and frequency filters 58 and 60 may filter the modulus 52 in increments. In some embodiments, an increment counter 54 increments for each sample of the acceleration modulus 52 (e.g., updating every 10 ms) computed by the processor 18. Each of the threshold and frequency adaptive filters 58 and 60 may filter a sample set 56 of the modulus 52 when the increment counter 54 counts 128 samples, for example. In other embodiments, different sample sizes may be used for filtering. In some embodiments, filtering is performed on immediately preceding sample sets 56 of the data and may be substantially dynamic.

In some embodiments, the threshold filter 58 involves filtering the modulus 52 based on a moving average acceleration modulus. Referring again to the graph 80 of FIG. 4, threshold-cross based step detection techniques involve detecting crossings about a threshold. A valid crossing may occur at every transition from a positive slope 86 of the modulus 52 to a negative slope 88 of the modulus 52 and between a negative slope 88 to positive slope 86 transition. In some embodiments, the crossings may be indicative of a step if other conditions are met, as will be discussed.

Threshold-cross based step detection techniques conventionally involve detecting a step based on acceleration swing about a fixed threshold, such as at 1 g. However, by using fixed threshold techniques, some steps may not be detected due to offsets or shifts in the accelerometer. For example, when a user of the device 10 is running, the average acceleration of the device 10 may be higher due to the greater acceleration of each footstep and the overall faster forward motion. Due to the higher offset of average acceleration during running measurements, some negative slope 88 to positive slope 86 threshold crossings may not be detected. For example, the negative slope 88 to positive slope 86 transition at point 94 in the graphed modulus 52 does not cross the 1 g threshold between peaks 92a and 90a. As a result, while peaks 92a and 90a may actually correspond to two steps (e.g., a left step and a right step), conventional threshold filtering techniques may detect only one step due to the lack of a negative to positive transition (e.g., point 94) crossing below the fixed 1 g threshold.

In one or more embodiments, adaptive threshold step detection involves detecting acceleration crossings, about a moving average 96. The moving average 96 may be calculated during frequency analysis of the acceleration module 52, as will be further discussed. The moving average 96 may be the calculated average acceleration magnitude based on an immediately preceding sample set of the acceleration modulus 52. As represented in the graph 80, because the moving average 96 is based on the average acceleration modulus 52 at each immediately preceding sample set, the moving average 96 is more likely to have an acceleration value between a negative to positive peak and a positive to negative peak (referred to as peak-to-peak) of the acceleration modulus 52. As such, significantly more peak-to-peak crossings of the modulus 52 may be detected about the moving average 96 than compared to crossings about the fixed threshold at 1 g. For example, while point 94 does not cross below the 1 g threshold, the point 94 may cross below the moving average 52, resulting in the correct detection of both of the steps 92a and 90a.

In addition to compensating for acceleration shifts, such as due to acceleration measurements of running steps, using the adaptive threshold filter 58 may also improve step detection by compensating for different locations which a user may wear or carry the device 10. For example, if the device 10 is carried in a right pocket of the user, the acceleration modulus 52 may have much greater peaks 90 corresponding to right leg steps but relatively lower peaks 92 corresponding to left leg steps. Furthermore, if the device 10 is worn on a user's body location which experiences relatively less movement during running or walking (e.g., a user's waist, chest, shirt collar, or arm) as opposed to on a body part which experiences greater motion (e.g., a user's pocket or leg), the acceleration modulus 52 may have relatively lower peaks 90 or 92. In some embodiments, because the moving average 52 adapts substantially dynamically to the acceleration modulus 52, the peak-to-peak swing about the moving average 96 may still have an acceleration value between the peaks of the acceleration swing, even when the peaks are relatively low. As such, the threshold peak-to-peak acceleration swing for detecting a valid crossing may be relatively lower than a conventional fixed threshold. In one embodiment, the threshold peak-to-peak swing may be approximately 0.2 g, which is significantly smaller than, for example, a conventional 1 g fixed threshold. As such, even imbalanced peaks or relatively lower peaks may result in detectable acceleration threshold crossings. Therefore, the threshold filtered data 62 may include acceleration modulus crossings which decreases the number of lost steps and increases the accuracy of step detection, in accordance with the present techniques.

The adaptive frequency filter 60 of the step detection system 50 involves adaptively filtering the dominant frequency 72 of the acceleration modulus 52 through a frequency band based on the frequency of the previous sample set of the acceleration modulus 52. Conventionally, frequency filter techniques involve filtering acceleration crossings which occur below a threshold frequency. For instance, a relatively low threshold frequency, such as 2.5 Hz (i.e., 2.5 steps per second) may detect steps for any crossings below 2.5 Hz and discard crossings which occur at frequencies higher than the low threshold. Although such a relatively low frequency threshold may successfully detect most walking steps, the threshold may not detect running steps which generally occur at a higher frequency (e.g., 2.5 Hz-4.5 Hz). Furthermore, a relatively higher threshold frequency, such as 4.5 Hz (i.e., 4.5 steps per second) may result in step detections for any crossings below 4.5 Hz, which may successfully detect most walking and running steps. However, by simply using a higher threshold frequency, higher frequency components in the acceleration data may be incorrectly counted as steps, resulting in inaccuracies in the step detection data.

In one or more embodiments, the adaptive frequency filter 60 may be suitable for filtering the acceleration modulus 52 through one of many frequency bands (i.e., range of frequency values), and may adjust the frequency filter 60 substantially dynamically based on the dominant frequency 72 of the modulus 52. As previously discussed, the adaptive frequency filter 60 may filter the previous 128 samples of the acceleration modulus 52. In some embodiments, the adaptive frequency filter 60 may use a 128 order finite impulse response (FIR) low pass filter, such as a Remez Equiripple or Parks-McClellan filter. As will be further discussed in more detail, frequency analysis 68 may be performed on the modulus 52 to determine the dominant frequency of previous samples of the modulus 52. The dominant frequency 72 of the previous modulus samples may represent an estimated pace (i.e., steps per second) of a user of the device 10. Therefore, frequencies which occur too far outside the current estimated pace are more likely to be the result of irregularities (e.g., shifting of the device 10 if the device 10 is loose in a user's pocket) and may not be the result of actual steps. Furthermore, as a user's pace may change throughout a measurement, the adaptive frequency filter 60 may also adjust to filter data through a different frequency band according to detected shifts in the dominant frequency 72 of the modulus 52.

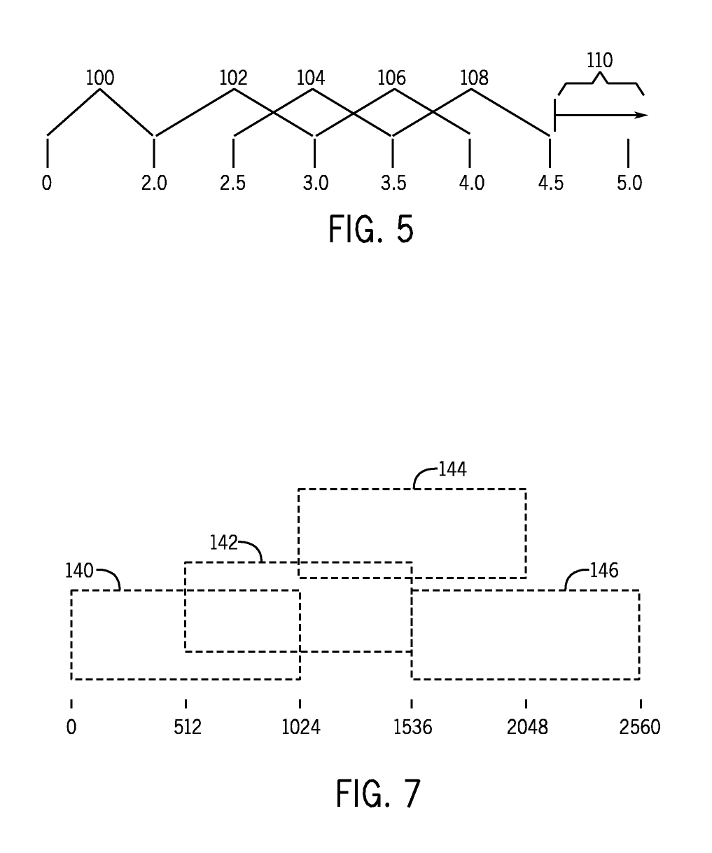

In some embodiments, the dominant frequency 72 of the acceleration modulus 52 may be filtered by one of several possible pace ranges. For example, FIG. 5 is an illustration of several frequency bands 100, 102, 104, 106, or 108 which each correspond to a walking or running pace range of a human. As illustrated in FIG. 5, the frequency band 100 may have a frequency range of 0.1 Hz-2.0 Hz, the frequency band 102 may have a frequency range of 2.1 Hz-3.0 Hz, the frequency band 104 may have a frequency range of 2.5 Hz-3.5 Hz, the frequency band 106 may have a frequency range of 3.1 Hz-4.0 Hz, and the frequency band 108 may have a frequency range of 3.1 Hz-4.5 Hz. Crossings having frequencies 110 above approximately 4.5 Hz generally may not be recognized as a step, as such a frequency may be above the average frequencies at which a human typically runs. As such, detected crossings 110 having frequencies outside of an estimated human pace range may be discarded as spurious steps or irregular movements of the device 10 and may not be counted as a step in the measurement.

For example, the dominant frequency 72 of the previously analyzed sample set of the modulus 52 may be approximately 2.3 Hz. Accordingly, the adaptive frequency filter 60 may apply the frequency band 102 to count the crossings occurring between a frequency range of 2.1 Hz through 3.0 Hz and discard crossings having frequencies above or below the frequency band 102. A higher frequency step at 4.4 Hz may be counted as a step in conventional high threshold frequency filters, but may be recognized as an irregularity (and not an actual step) using the present adaptive filtering techniques. Therefore, the frequency filtered data 64 may increase the accuracy of step detection, in accordance with the present techniques.

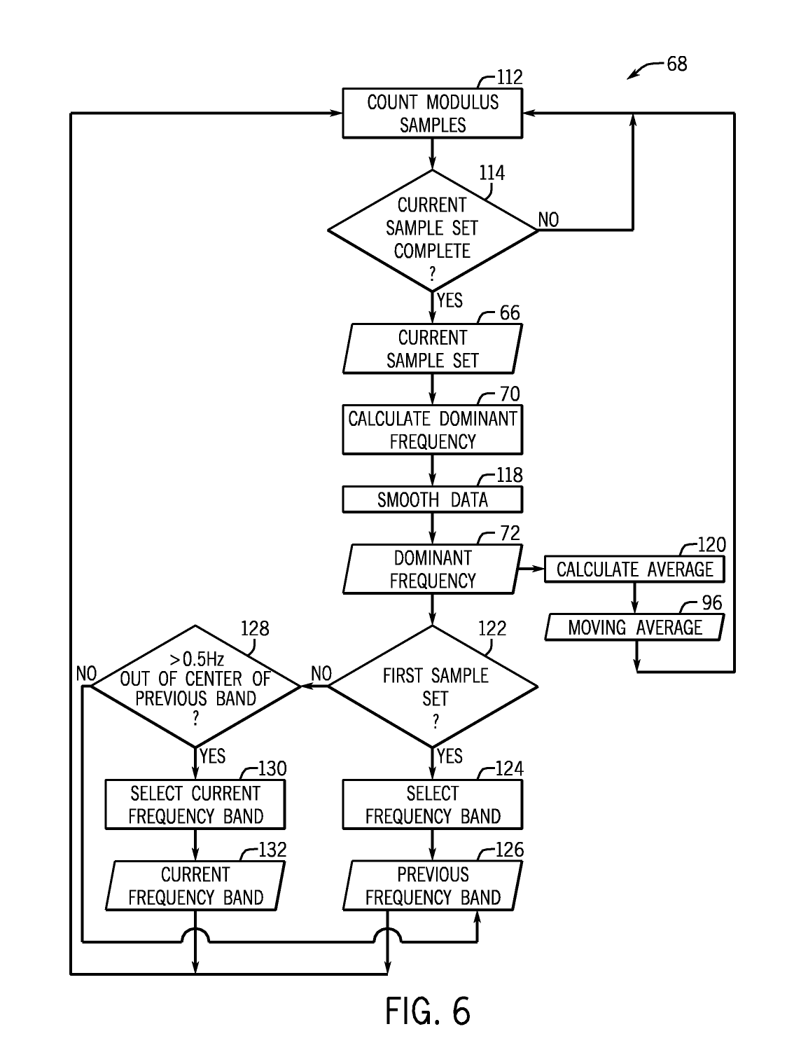

The adaptive threshold filter 58 and the adaptive frequency filter 60 may be adaptable during a measurement based on frequency analysis 68 of the data. Frequency analysis is represented in the step detection system 50 of FIG. 3 and illustrated in greater detail in FIG. 6, which is a flow chart representing a frequency analysis process 68 and in FIG. 7, which is a schematic diagram representing sample sets used for frequency analysis. Accordingly, FIGS. 3, 6, and 7 may be discussed concurrently.

In some embodiments, frequency analysis 68 is performed in increments for each set of samples of the acceleration modulus 52. The increment counter 54 may count (block 112) each sample of the modulus 52 to obtain an appropriately sized sample set 66 for frequency analysis 68. In some embodiments, frequency analysis 68 may be performed on a sample set 66 including 1024 samples of the acceleration modulus 52. For example, as illustrated in FIG. 7, each of the sample sets 140, 142, 144, and 146 may include 1024 samples of the acceleration modulus 52. While the sample sets 140, 142, 144, and 146 may be illustrated as vertically offset from one another, the sample sets are merely offset for clarity purposes. Furthermore, frequency analysis may be performed for different sized sample sets. For example, in some embodiments, frequency analysis may be performed for smaller sample sets (e.g., 128 samples, 512 samples, etc), or for larger sample sets.

In some embodiments, each sample set may include samples from a previously analyzed sample set. For example, as illustrated in FIG. 7, the second sample set 142 may include a 50% overlap of the later 512 samples from the first sample set 142. Likewise, the third sample set 144 includes a 50% overlap of the later 512 samples from the second sample set 142, and the fourth sample set 146 includes a 50% overlap of the later 512 samples from the third sample set 144, and so forth. Because frequency analysis 68 is performed at each new 512 samples (after the initial 1024 samples), a system 50 operating at 100 Hz may perform frequency analysis 68 on an old 512 samples and a new 512 samples every 5.12 seconds. In some embodiments, the 50% overlap between each current sample set with each previous sample set may increase the resolution granularity of the frequency analysis 68 of the acceleration modulus 52. Furthermore, the overlapping samples may result in more frequent and more responsive updates in frequency analysis, as shifts or adjustments in the dominant frequency 72 may be more quickly detected. Moreover, in some embodiments, as frequency analysis is performed on immediately preceding sample sets of the acceleration modulus 52 during a measurement of the device 10, the frequency analysis 68 and the adaptive filters 58 and 60 which are adapted based on the frequency analysis 68 may be substantially dynamic.

A suitable processor 18 (FIG. 1) may determine (block 114) when a current sample set 66 is complete and perform frequency analysis 68 on the current sample set 66. The frequency analysis process 68 includes calculating (block 70) the dominant frequency 72 of the acceleration modulus 52. For example, calculating (block 70) the dominant frequency 72 may include fast Fourier transform (FFT), or any other suitable algorithm for determining the dominant frequency 72 in the modulus 52. While the acceleration modulus 52 may include various motion data (e.g., shaking or rocking of the device 10), the dominant frequency 72 may represent the dominant motion of the device 10 and may correspond to motions of a user carrying the device 10. In some embodiments, frequency analyzed data is further smoothed (block 118) to determine the dominant frequency 72. Smoothing (block 118) the data may include the detection of irregularities and rejection of spikes. For example, removing such irregular frequencies from the dominant frequency 72 may decrease frequent transitions between different frequency banks during frequency filtering.

In some embodiments, the frequency analysis process 68 includes calculating (block 120) the average acceleration value of the dominant frequency 72 of each current sample set 66. The calculated average is referred to as the moving average 96, as previously discussed with respect to FIGS. 3 and 4, and may be used by the adaptive threshold filter 58 to detect peak-to-peak threshold crossings.

The frequency analysis process 68 may also include selecting (block 124) a frequency band of the dominant frequency 72 for adaptive frequency filtering 60. In some embodiments, if the process 68 determines (block 122) that the current sample set 66 is the first sample set (e.g., first sample set 140), a frequency band 126 may be selected (block 124) based on the calculated dominant frequency 72. For example, if the dominant frequency 72 is 3.3 Hz, the frequency band 106 (FIG. 5) may be selected as the first frequency band 126. If the current sample set 66 is not the first sample set, the frequency analysis process 68 may involve determining (block 128) whether the dominant frequency 72 of the current sample set 66 is greater than 0.5 Hz out of the center of the previous frequency band 126 of the previous sample set. For example, if the dominant frequency has dropped to 2.9 Hz, the frequency may be greater than 0.5 Hz from the center of the frequency band 106 (i.e., 3.5 Hz). In such instances, the frequency analysis process 68 may include selecting (block 130) a current frequency band 132 based on the current dominant frequency 72. For instance, if the current dominant frequency is 2.9 Hz, the process 68 may select the frequency band 104.

In some embodiments, the condition of selecting (block 130) a different frequency band 132 based on a shift in frequency greater than 0.5 Hz from the center of the previous frequency band 126 may reduce the number of transitions between different frequency bands. As will be appreciated, transitioning between different filter banks may reset the filter state, possibly resulting in dropped steps. Furthermore, in some embodiments, a different frequency change threshold (e.g., 0.3 Hz, 0.4 Hz, 0.6 Hz, etc.) may be used to determine transitions between different frequency bands.

Based on the frequency analysis process 68, the adaptive threshold filter 58 may adaptively filter the peak-to-peak crossings of the modulus 52 about a moving average 96, and the adaptive frequency filter 64 may filter the crossings through a selected frequency band filter. Based on the threshold-filtered and frequency-filtered data 62 and 64, the step counter 74 may detect steps 76. In accordance with the present techniques, the steps 76 may include peak-to-peak crossings about the moving average 96 of the adaptive threshold filter 58 which fit in the current frequency filter band of the adaptive frequency filter 60.

In some embodiments, the step counter 74 may be suitable for differentiating between running steps and walking steps. Typically, the frequency of running steps may be higher (e.g., 2.5 Hz or above) than the frequency of walking steps (e.g., below 2.5 Hz). Therefore, in some embodiments, the step counting circuitry may be connected to processing circuitry 75 suitable for determining whether each step is a running step or a walking step based on the frequency of the step. The frequency of each step may be based on the frequency filtered data 64. For example, the frequency filtered data 64 may indicate the frequency of each step and/or the frequency band in which each step is filtered, which may be used to determine whether each step is a running step or a walking step.

Furthermore, in some embodiments, in addition to using step frequency to determine whether a detected step is a walking step or a running step, walking steps and running steps may be differentiated using time domain and/or frequency domain parameters. For example, time domain parameters may include root mean square acceleration (RMS), mean absolute differential value (MADV), acceleration variance, cube root of velocity, and fourth root of acceleration difference. Frequency domain parameters may include, for example, step frequency, signal energy, signal entropy, frequency, the multiple of frequency and entropy, and the difference between acceleration variance and energy. Such parameters may be used by a machine learning model in the processing circuitry 75, such as a support vector machine (SVM), a decision tree, etc., to predict whether the user is walking or running based on the time domain and/or frequency domain parameters.

In some embodiments, differentiation between walking steps and running steps may result in more accurate distance estimations. Conventionally, distance estimation techniques involve calculating distance by multiplying a step count with an estimated stride length. However, walking steps and running steps typically have a different stride length. For example, for most humans, an estimated walking stride length is between 0.7 m-0.9 m while an estimated running stride length is between 0.8 m-1.8 m. In one or more embodiments, the device 10 may calculate distance based on the number of detected running steps, the number of detected walking steps, and estimated stride lengths for either walking steps or running steps.

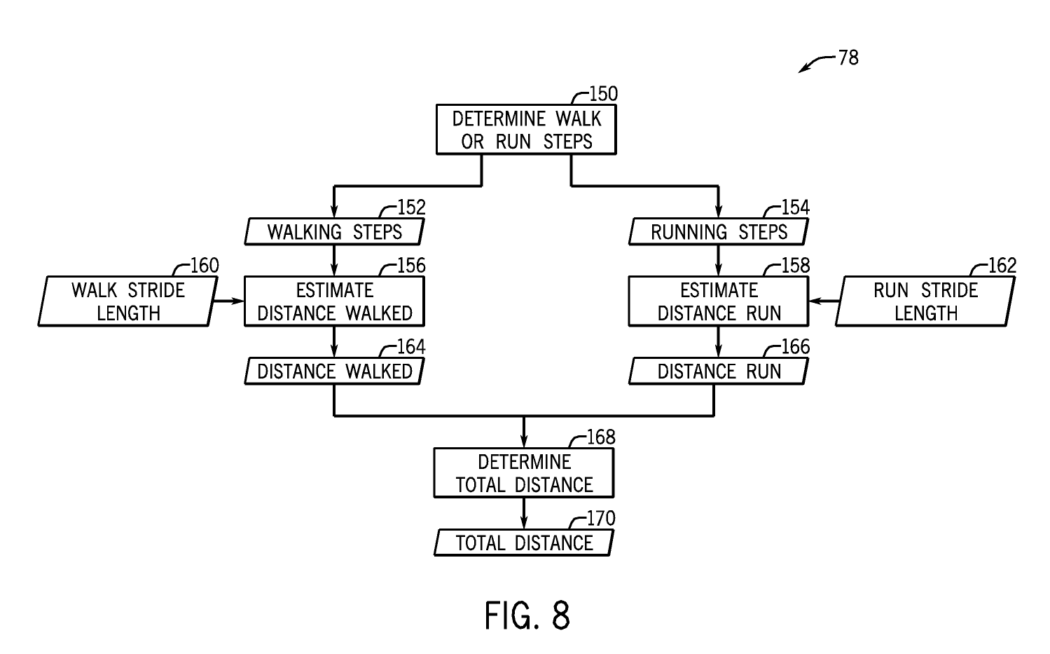

A flow chart of a distance analysis process 78 is provided in FIG. 8. The process 78 may involve determining (block 150) the number of walking steps 152 or running steps 154. As discussed, step counts for walking steps 152 and running steps 154 may be determined by the step counter 74 (FIG. 3) or by a suitable processor 18 (FIG. 1) of the device 10 based on the frequency of each detected steps. The process 78 may then involve estimating (block 156) the distance walked 164 by multiplying the number of walking steps 152 with an estimated walking stride length 160 and estimating (block 158) the distance run 166 by multiplying the number of running steps 154 with an estimated running stride length 162. The distance walked 162 and the distance run 166 may be added to determine (block 168) the total distance 170. In some embodiments, the device 10 may be suitable for displaying the total distance 170 traveled during the measurement, and may further display the total distance walked 164 and total distance run 166.

As will be appreciated, walking stride length 160 and running stride length 162 may vary between different users of a device 10, and may even vary for a particular user of the device 10 and throughout a user's use of the device 10 to measure an activity. A number of parameters may affect the length of a user's stride including, for example, the time domain parameters, frequency domain parameters, and user-specific parameters. For example, time domain parameters may include root mean square acceleration (RMS), mean absolute differential value (MADV), acceleration variance, cube root of velocity, and fourth root of acceleration difference. Frequency domain parameters may include, for example, step frequency, signal energy, signal entropy, frequency, the multiple of frequency and entropy, and the difference between acceleration variance and energy. User-specific parameters may include, for example, gender, height, and weight.

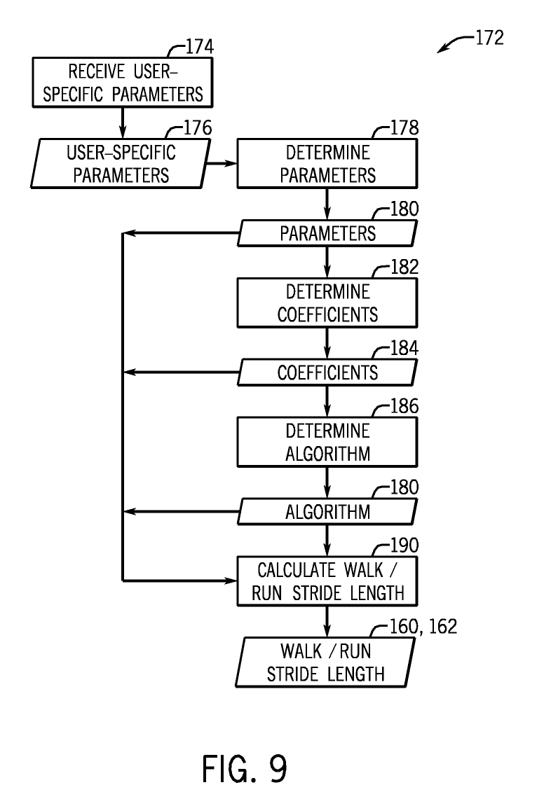

Since a user's stride length may vary depending on a variety of parameters, in some embodiments, the device 10 may store certain parameters or receive user-specific parameters for improved estimation of stride length and/or distance. For example, as depicted in the flow chart of FIG. 9, a process 172 for estimating walking or running stride length 160 and 162 is provided. In some embodiments, a user may interact with the device 10 (e.g., through a GUI 38) by entering (block 174) user-specific parameters into the device 10 before or after a measurement. For example, the user may enter data such as the user's gender, height, and/or weight. The device 10 may receive the user-specific parameters 176, and depending on the user-specific parameters 176 and characteristics of the user's acceleration data, determine (block 178) which parameters may affect the user's stride length.

In some embodiments, parameters which affect a user's stride length may be determined (block 178) by, for example, multicollinearity analysis. Such analyses may be performed using various statistical measures such as bivariate correlations, variance inflation factors, etc., to determine the parameters 180 which are highly correlated to stride length, but which have minimum inter-parameter correlation (i.e., parameters which have an orthogonal relationship to one another). Highly correlated parameters 180 may include frequency domain parameters, time domain parameters, or user-specific parameters 176 which significantly affect a user's stride length. Once the parameters 180 are determined, the process 172 may determine (block 182) coefficients 184 based on a multiple regression on the population data. In some embodiments, the process 172 involves determining (block 186) a suitable algorithm 188 for calculating (block 190) a stride length based on the parameters 180 and/or coefficients 184. In some embodiments, the parameters 180 and coefficients 184 may be combined into a linear fit algorithm such as a best fit algorithm or a root mean square error algorithm. For example, an estimated stride length may be represented by the equation (1) below:

Estimated Stride=A₀+A₁*P₁+A₂*P₂+A₃*P₃+ . . . equation (1)

where A represents the coefficients 184 and P represents the parameters 180 which are determined to be highly correlated and likely to affect a user's stride length 160 or 162.

In some embodiments, the parameters, coefficients, and algorithms for calculating an estimated stride may be stored in a suitable memory component 20 (FIG. 1) of the device. For example, in some embodiments, the various frequency domain and time domain parameters may be computed based on the acceleration data 51 while the step detection system 50 is actively measuring an activity. The computed parameters may be stored in the memory 20 and either retrieved dynamically to provide a substantially real-time estimate of distance traveled (based on current step count and estimated stride length) or retrieved after a measurement of an activity is complete to provide a total walk/run steps counted and/or distance traveled. Furthermore, in some embodiments, data for determining the coefficients 184, such as population data, may also be stored in the memory 20 to be retrieved when the device 10 performs the process 172 for calculating walking or running stride lengths 160 and 162.

It should be noted that although one flow chart (FIG. 9) is provided for explaining the calculation of both walking and running stride lengths, the calculation of walking stride length 160 and running stride length 162 may be different, as different parameters 180 may affect the estimation of a walking stride length 160 and a running stride length 162. For example, a walking stride length 160 may be calculated based on parameters such as fourth root of acceleration difference, RMS, step frequency, and user height, and a running stride length 162 may be calculated based on parameters such as MADV, cube root of velocity, the difference between acceleration variance and energy, the multiple of frequency and entropy, and user height.

In one or more embodiments, the distance analysis may enable a calculation of calories burned during the measured activity. For example, calories may be computed based on total distance traveled 170, and/or based on a combined distance walked 164 and distance run 166. An example calculation of calories burned for a distance walked is provided in equation (2), and an example calculation of calories burned for a distance run is provided in equation (1):

Calories expended_{walking}=Distance (km)*Weight (kg)*0.72604 equation (2)

Calories expended_{running}=Distance (km)*Weight (kg)*1.0274 equation (3)

In some embodiments, algorithms and data suitable for calculating calories may be stored in a suitable memory 20 of the device 10.

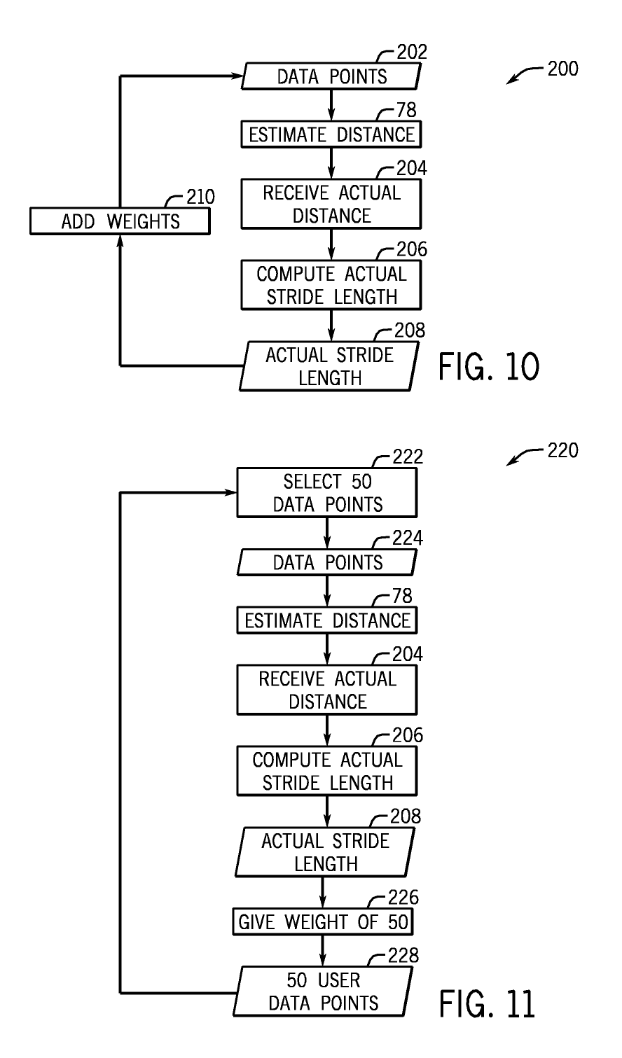

The present techniques also involve calibration after a measurement to further increase the accuracy of future stride length and/or distance calculations. In one embodiment, a least squares simple regression, referred to as simple regression calibration, may be used to calibrate an estimated stride length. A flow chart representing a simple regression calibration process 200 is provided in FIG. 10. The simple regression calibration process 200 may include estimating (block 78) the distance based on a best fit curve between two data points 202. In one embodiment, the two data points 202 may be the 15^{th} and 85^{th} percentile points, for example, of estimated stride length based on population data. The device 10 may estimate (block 78) the distance using the stride length data points 202 based on the distance analysis process discussed with respect to FIG. 8. A user of the device 10 may then enter the actual distance traveled. The actual distance traveled may be known by the user, for example, if the user is conducting the measurement on a treadmill or on a track having measurements, or if the user otherwise knows of the actual distance traveled during the measurement of an activity with the device 10.

The actual distance traveled may be received (block 204) and used to compute (block 206) an actual stride length 208, and the actual stride length 208 may be implanted in the simple regression calibration as a new data point. A new slope may be found by performing a linear fit on the three data points (i.e., the 15^{th} percentile, 85^{th} percentile, and new data points). In some embodiments, each new data point may be weighted (block 210), for example, to twice the weight-age, to skew the linear fit model towards the user.

In another embodiment, a least squares multiple regression may be used to calibrate stride length. A flow chart representing a multiple regression calibration process 220 is provided in FIG. 11. The multiple regression calibration process 220 may include selecting (block 222) a number of data points (e.g., 50 data points) 224 from population data. For example, in some embodiments, the 50 data points 224 may be selected between the 5^{th} percentile to the 95^{th} percentile of the population data. Each data point may be represented by parameters such as the MADV, the difference between signal variance and signal energy, the multiple of dominant frequency with frequency-domain entropy, user height, and average stride. The process 220 may involve estimating (block 78) the distance based on a best fit curve of the 50 data points 224.

A user of the device 10 may then enter the actual distance traveled. The actual distance traveled may be received (block 204) and used to compute (block 206) an actual stride length 208, and the actual stride length 208. The multiple regression process 220 may then weight (block 226) the new data point (e.g., to 50 data points) 228. The 50 user data points 228 may then be combined with the 50 population data points, and a least-square fit may be performed on the new 100 data points to estimate a calibrated distance. In the simple regression and multiple regression processes 200 and 220, the population data may be stored in a suitable memory 20 of the device 10 and retrieved when calibration is performed. Moreover, new data points (e.g., data points 208 and 228) may also be stored to calibrate future calculations.

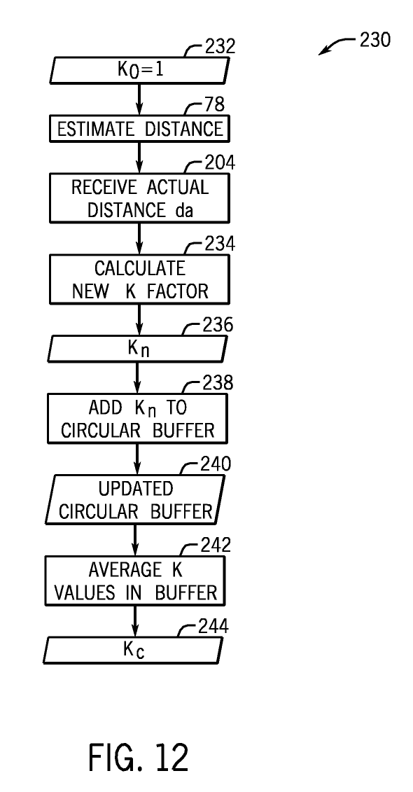

In some embodiments, a K-factor calibration technique may be used to calibrate the stride length and distance estimation of the device 10. The flow chart of FIG. 12 represents a K-factor calibration process 230. Generally, the K-factor represents a ratio between actual and estimated values. In accordance with the present techniques, the K-factor may be represented by actual distance divided by estimated distance. Before the first K-factor calibration of the device 10, the original K-factor, also referred to as the out-of-box K factor or Kₒ may equal 1, which assumes that actual distance is equal to estimated distance.

The K-factor calibration process 230 may involve estimating (block 78) the distance based on techniques discussed with respect to FIG. 8. A user may enter the actual distance traveled to calibrate future estimates or calculations by the device 10. The device 10 may receive (block 204) the actual distance (dₐ) and calculate (block 234) the new K-factor, Kₙ 236. The Kₙ-factor may be calculated by dividing the actual distance dₐ by the estimated distance.

In some embodiments, the Kₙ-factor may be added (block 238) to a circular buffer, and when a user calibrates a measurement, the K-factor values in the updated circular buffer 240 may averaged (block 242), resulting in a current K-factor K_{c}. The K(_{c}-factor may be stored in memory (e.g., memory 20 in FIG. 1) for use in a following measurement. For example, in a following measurement, the device may determine an uncalibrated distance estimate based on techniques discussed with respect to FIG. 8, and may determined a calibrated distance estimate by multiplying the uncalibrated distance estimate by the K(_{c}-factor.

By using the K-factor calibration process 230, population data may not be necessary, as the circular buffer may store data points (each new Kₙ-factor) based on calibrations initiated by the user and actual distances entered by the user. In some embodiments, the circular buffer and algorithms for performing the K-factor calibration process 230 may be configured or stored in a suitable memory 20 of the device 10.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A method for analyzing motion data, the method comprising:
calculating a dominant frequency from a current sample set of the motion data, wherein the current sample set comprises a first sample portion and a second sample portion, wherein the first sample portion comprises samples previously analyzed in an immediately preceding sample set from the current sample set.

2. The method of claim 1, comprising determining that a current sample set is complete before calculating the dominant frequency from the current sample set.

3. The method of claim 2, wherein determining that the current sample set is complete comprises determining that the current sample set comprises 1024 samples of the motion data.

4. The method of claim 2, wherein determining that the current sample set is complete comprises determining that the current sample set comprises 512 samples in the first sample portion and 512 samples in the second sample portion.

5. The method of claim 1, wherein calculating the dominant frequency comprises performing a fast Fourier transform (FFT) dominant frequency computation on the motion data.

6. The method of claim 1, wherein the motion data comprises a modulus signal comprising a magnitude of acceleration data, wherein the acceleration data is detected by a motion sensor of an electronic device.

7. The method of claim 6, wherein the dominant frequency comprises a transform of the modulus signal.

8. The method of claim 6, comprising calculating an average acceleration magnitude of the modulus signal in the current sample set, resulting in a moving average.

9. The method of claim 8, comprising transmitting the moving average to a threshold filter configured to filter the modulus signal based on the moving average.

10. The method of claim 1, comprising transmitting the dominant frequency to a frequency filter configured to filter the modulus signal based on the dominant frequency.

11. The method of claim 1, wherein the dominant frequency comprises an estimate of a motion of an electronic device from which the motion data is detected.

12. The method of claim 1, comprising smoothing the dominant frequency to reject irregularities from the calculated dominant frequency.

13. The method of claim 1, comprising detecting a step based on the dominant frequency calculation and determining whether the detected step is a running step or a walking step based on the dominant frequency calculation.

14. The method of claim 13, wherein determining whether the detected step is a running step or a walking step is based on one or more parameters of the motion data, wherein the parameters comprise root mean square acceleration (RMS), mean absolute differential value (MADV), acceleration variance, cube root of velocity, fourth root of acceleration difference, step frequency, signal energy, signal entropy, frequency, the multiple of frequency and entropy, the difference between acceleration variance and energy, or combinations thereof.

15. An electronic device comprising one or more processors configured to:
receive a motion signal comprising a magnitude of acceleration data detected by the electronic device;
calculate a dominant frequency of a previous sample set of the motion signal, wherein the previous sample set comprises a first sample portion and a second sample portion; and
calculate a dominant frequency of a current sample set of the motion signal, wherein the current sample set comprises the second sample portion and a third sample portion.

16. The electronic device of claim 15, comprising a motion sensor configured to detect the acceleration data, wherein the motion sensor is a three-axis accelerometer and the acceleration data comprises acceleration signals in the x-axis, y-axis, and z-axis.

17. The electronic device of claim 15, wherein the one or more processors is configured to calculate a magnitude of the acceleration data to produce the motion signal.

18. The electronic device of claim 15, wherein each of the first sample portion, second sample portion, and third sample portion comprises 512 samples.

19. The electronic device of claim 15, wherein the one or more processors is configured to calculate the dominant frequency by performing a fast Fourier transform (FFT) dominant frequency computation on the motion signal.

20. The electronic device of claim 15, wherein the one or more processors is configured to determine a total number of steps walked and a total number of steps ran based on the dominant frequency calculations.

21. The electronic device of claim 20, wherein the one or more processors comprises a machine learning model configured to analyze one or more parameters of the motion signal, wherein the one or more parameters comprise root mean square acceleration (RMS), mean absolute differential value (MADV), acceleration variance, cube root of velocity, fourth root of acceleration difference, step frequency, signal energy, signal entropy, frequency, the multiple of frequency and entropy, the difference between acceleration variance and energy, or combinations thereof.

22. The electronic device of claim 15, comprising memory configured to store algorithms and data associated with calculating the dominant frequency.

23. The electronic device of claim 15, comprising memory configured to store the calculated dominant frequency.

24. A method comprising:
calculating a dominant frequency of a motion modulus signal for each of a plurality of consecutive sample sets of the motion modulus signal, wherein the motion modulus signal comprises a magnitude of acceleration data, and wherein each sample set of the plurality of consecutive sample sets comprises samples from an immediately preceding sample set.

25. The method of claim 24, wherein each sample set overlaps with the immediately preceding sample set by half of the samples in each of the plurality of consecutive sample sets.

26. The method of claim 24, wherein each of the plurality of consecutive sample sets comprises 1024 samples.

27. The method of claim 24, comprising processing the calculated dominant frequency to remove irregularities of the dominant frequencies.

28. The method of claim 24, wherein calculating the dominant frequency of the motion modulus signal comprises performing a fast Fourier transform (FFT) dominant frequency computation on the motion modulus signal.

29. The method of claim 24, comprising detecting inactive periods based on the motion modulus signal and discarding samples associated with the inactive periods from dominant frequency calculation.
